(19) United States
(12) Patent Application Publication
(10) Pub. No.: US 2013/0004929 A1
(43) Pub. Date: Jan. 3, 2013

(54) EDUCATIONAL SYSTEM AND METHOD FOR CREATING LEARNING SESSIONS BASED ON GEO-LOCATION INFORMATION

(75) Inventor: Ken Otwell, (US)

(73) Assignee: Laureate Education, Inc., Baltimore, MD (US)

(21) Appl. No.: 13/429,063

(22) Filed: Mar. 23, 2012

Related U.S. Application Data
(60) Provisional application No. 61/466,655, filed on Mar. 23, 2011.

(51) Int. Cl. G09B 5/00

(52) U.S. Cl. 434/350

(57) ABSTRACT

A location based system for conducting learning sessions comprises a geolocation server that is configured to access location information for students and/or teachers. Geo-location information as used herein comprises student or teacher location information or relative proximity of students to each other, teacher to students as well as teacher or students relative to a place of interest. An enrollment module is configured to enroll the students in courses that are taught by teachers. A learning session management module is configured to manage learning sessions associated with the courses based on student location information and/or teacher location information.

### CROSS-REFERENCE OF RELATED APPLICATION

This application claims priority to U.S. Provisional Application No. 61/466,655, filed Mar. 23, 2011, the entire contents of which are hereby incorporated by reference.

### FIELD OF THE INVENTION

### Background of Invention

This invention relates to the field of educational systems in general and to educational systems and method for creating remote learning sessions and for remote delivery of instructional material.

With developments in the education industry, students seek access to course-related information and their own course work, anywhere, anytime. Student want current, relevant, interesting and engaging course materials and assignments taught by teachers, instructors, counselors and advisors who are aware of student's educational and professional path and goals based on a clear map of course progress and degree program. Enabling and facilitating students' online activities around their campus is a major consideration in providing the desired student experience.

Online education now demands providing educational services to a diverse global audience from different cultural backgrounds. Education providers face the challenge of providing high quality education across a diverse student population. Educational programs must provide skills that students can apply in their lives and professions to make a real difference in the real world. Educators must strive to create a community of learners connected to one another.

A learning management system (LMS), as referred to in the art, is software for delivering, tracking and managing training of students. LMSs range from systems for managing student training records to software for distributing courses over the Internet and offering features for online collaboration. In many instances, LMSs are used to automate record-keeping as well as to register students for classroom and online courses. Self-registration, faculty-led learning, learning workflow, the provision of on-line learning (e.g., read and understand), on-line assessment, management of continuous professional education (CPE), collaborative learning (e.g., application sharing, discussion threads), and learning resource management (e.g., instructors, facilities, equipment), are various aspects of LMSs.

FIG. 1 is a diagram depicting a known LMS 10, including one offered by Blackboard, WebCT, Moodle, eCollege and others, which allows a faculty member to place his or her courses, in whole or in part, online. As depicted, the faculty 12 plays a central role for mediating between a student 13, presenting course content 15 and assessing a student 14. LMSs 10 usually provide all-inclusive learning environments for faculty and students, with the faculty 12 disseminating instructional material specific to a course of study amongst students. As such, the faculty member serves as the facilitator, assessor and content developer.

Conceptually, there is no difference between the role of a teacher in conventional LMSs 10 and the role of a teacher in a bricks and mortar classroom. In both cases, the students are grouped and assigned a specific teacher. The teacher introduces all course content and materials into the classroom and mediates and assesses the learning process of the student. Thus, under LMS 10, the web is a tool to replicate, as closely as possible, the traditional classroom environment and the LMS 10 is limited by its system boundaries, just as the physical classroom is limited by four walls and doors.

With advances in content and media delivery technologies, the LMS model has not fully taken advantage of the available features for educating students. For example, such advances allow students to access educational content not only via laptops and desktops, but also smart phones, PDA's, iPods, Netbooks and eBooks. It is, for example, estimated that the majority of prospective student market has a smart phone or PDA, with advances content delivery capabilities via downloadable applications or by content streaming. These new devices have enabled users access to podcasting, wikis, blogs, web cams, eBook readers, MP3 players, social networks and virtual learning environments.

Conventional LMS developers' attempt in incorporating new features into their existing systems in some cases can result in significant developments cost in redesigning their content to incorporate the functionality of these new technologies. In other cases, the developers may have to open up their system platform through application programming interfaces (API's) to “bolt on” new technological capabilities. LMS redesign investment may be expensive, especially when new development work may not be able to keep up with the proliferation of ever advancing technologies and features. Opening up platforms through APIs may present a significant competitive disadvantage to LMS vendors and service providers who have invested heavily in their proprietary instructional material delivery systems.

Additionally, educational services are increasingly offered over global networks of institutions and universities. For example, Laureate Education Inc., the assignee of the present application, currently offers accredited campus-based and online courses in a wide variety of programs, including undergraduate and graduate degree programs and specializations, to nearly a wide range of students in numerous countries. Such a global educational network requires supporting learning environments that are tailored to bring to students a global perspective blended with a local point of view, creating a truly multicultural, career-oriented educational experience for students. For example, the educational experience may be a career-focused or licensing program, a multi-year undergraduate degree program, or master's and/or doctorate degree program in any one of a number of fields including engineering, education, business, health care, hospitality, architecture, and information technology, etc.

Laureate Education Inc.'s U.S. Patent Publication No. US 2009-0291426 A1 discloses an “Educational System For Presenting One Or More Learning Units To Students In Different Learning Environments”, where each unit is associated with an assessment information relating to students. A digital rights and asset management application controls access to the content associated with each one of said one or more units according to corresponding unit identifiers. An assessment application, e.g., a grade book application, stores assessment information derived from presenting the content to said one or more users in the first and second interactive environments, with the unit identifier correlating the assessment information with the units.

Laureate Education Inc.'s U.S. Patent Publication No. 2009-0311658 A1 discloses “System And Method For Collaborative Development Of Online Courses And Programs Of Study” over a social network. A database stores an initial framework that defines a sequence of learning units for creating a desired learning environment for students. The learning units are identified by corresponding learning unit identifiers. A plurality of workstations coupled to the network are used for entry of reviewer information by the participants using the learning environment created for the students. The reviewer information comprise one or more comments entered by one participant about a learning unit and a rank entered by another participant about the comment, with the rank being correlated with a defined ranking standard. A processor processes the rank according to a predefined criteria to produce a ranking result that is associated with a learning unit identifier. The ranking result is used for associating learning content to the learning unit identified by the learning unit identifier.

Also known are location based systems (LBS). An LBS relies on geo-location information fort tracking persons and objects. For example, LBS has been applied to online advertising for delivery of tailored advertiser content based on user location. Event based applications have been used in conjunction with LBS to perform functions based on satisfaction of a position criteria. The term “geolocation” refers to the identification of geographic coordinates of objects that are associated with persons. The objects could be devices associated with users of such devices. LBS applications use known geo-location processes and methods to determines the geographic coordinates of remote wireless devices, e.g., smart phones or Internet-connected laptops, for example, a street address. A widely used geo-location system processes longitude and attitude information received from the Global Positioning Satellites for determining geographic coordinates of devices that are associated with GPS receivers. Other geo-location processes determine geographic location based on the Internet Protocol (IP) or MAC addresses associated with devices, as well as the locations of base station associated with mobile devices in a cellular network, such as a GSM network, or access point location of Wi-Fi networks.

With advances in information technologies, a need exists for an educational system that can easily implement advances in learning technology for creating learning sessions based on geo-location information.

### SUMMARY OF THE INVENTION

Briefly, according to the present invention, a location based system for conducting learning sessions comprises a geolocation server that is configured to access location information for students and/or teachers. Geo-location information as used herein comprises student or teacher location information or relative proximity of students to each other, teacher to students as well as teacher or students relative to a place of interest. An enrollment module is configured to enroll the students in courses that are taught by teachers. A learning session management module is configured to manage learning sessions associated with the courses based on student location information and/or teacher location information.

According to some of the more detailed features of the invention, managing the leaning session comprises matching one of students enrolled in a course with a teacher that teaches the course based on a relative proximity of the student and the teacher. Alternatively, managing the learning session comprises creating the learning session associated with a course when a number of students that are within a relative proximity exceeds a predefined number. In one embodiment, creating the learning session requires sending a session invitation to a student.

According to other more detailed features of the invention, managing a leaning sessions comprises matching a student enrolled in a course with another student enrolled in the course based on relative proximity of the students. In one embodiment, the geolocation information is associated with a place of interest related to a course. Under this arrangement, managing the leaning session comprises matching a student enrolled in the course based on a relative proximity of the student to the place of interest.

According to yet more detailed features of the invention, managing a learning session comprises delivering instructional material associated with a course to a student enrolled in the course based on the location of the student or teacher.

### BRIEF DESCRIPTION OF THE DRAWINGS

FIG. 1 is a diagram depicting a known LMS.

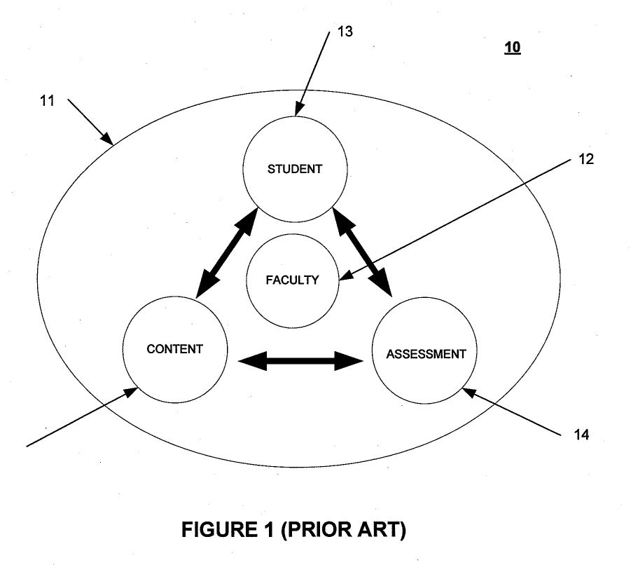

FIG. 2 is a block diagram of one embodiment of an educational system that uses geo-location information for educational courses.

FIG. 3, the present invention associates geo-location information with profiles that comprise student information, course information, location information, learning unit information and instructional material information.

FIG. 4 shows the block diagram of a network having a front-end system and a back-end system.

FIG. 5 depicts a student profile example stored and accessed by the geolocation server.

FIG. 6 depicts a teacher profile stored and accessed by the geolocation server.

FIG. 7 depicts a place of interest profile stored and accessed by the geolocation server.

FIG. 8 depicts an activity profile stored and accessed by the geolocation server.

FIG. 9 shows an exemplary schematic diagram of instructional content delivery triggered by a student's geographical location.

FIG. 10 shows a schematic diagram of engagement of at least one student and a teacher in a learning session based on geographical location and/or proximity of the student and the teacher to one another.

FIG. 11 shows another embodiment of FIG. 10, whereby the geolocation educational system may engage two sets of students and teachers based on geographical location and/or proximity of the students and teachers to one another.

FIG. 12 shows a schematic diagram of student collaboration and communication based on geographical location and/or proximity of two or more students.

FIG. 13 depicts a schematic diagram of collaboration between teachers based on geographic proximity and similar field of education.

FIG. 14 shows a schematic diagram wherein at least one student and teacher are engaged in a learning session based on geographical location and/or proximity of the student and teacher to one another.

FIG. 15 shows a schematic diagram of a scenario wherein a teacher engages at least one student in a learning session based on an event.

FIG. 16 shows a schematic diagram of a scenario wherein a student engages him- or herself in a learning session based on an event.

FIG. 17 depicts a web portal displaying geolocation information to a user.

### DETAILED DESCRIPTION

The design concepts associated with the present invention break the course-centric LMS model and enable the student to access any content at any time and anywhere based on geolocation information. The system provides configurable indicators of progress, alerts, and deadlines as well as an integrated event calendar. In one embodiment courses could be organized by lessons or learning units that rely on a variety of instructional media, discussion forums and live-chat between students and various levels of groupings such as class, section, course, department, school, classmates, arbitrary groupings. The present invention provides electronic portfolios as well as student and student-accessible faculty blogs, access to grades and progress reports by program and course, and comparative ranking against appropriate population group.

Geolocation comprises determining or identifying locations of various users, such as students, teachers and classmates as well as student's family and friends. The present invention applies geolocation technology to mobile technology to enable conducting learning sessions in new locations and contexts, away from traditional school settings. While traditional online or fixed-location education systems may feel isolating at least to some student, the present invention uses geolocation information to enhance students' educational experiences within a location tailored learning environment. Geolocation technology may be used in many different contexts within the education environment as further described below.

For determining geographic location, the present invention can use any known positioning systems, such as GPS, passive or active tags as well as positioning process, such as those known in the Internet, wide area GSM or local Wi-Fi wireless networks. The determined geographic locations are associated with wireless student work stations that comprise one or more processing units connected to servers for receiving and delivering instructional material to students under various types of learning environments, including social networking.

Social networks implemented according to the present invention create communities of students/learners and teachers/facilitators around a variety of shared learning interests. While enabling appropriate communication and feedback between students, a sense of presence is created that breaks down the online distance and enable students to control and calibrate their own personal space within each class or learning session to satisfy their individual needs. The system implements interaction channels, such as private chat, group chat blog, e-mail, visual or voice lectures. The geolocation information according to the present invention could be used to serve instructional material to multiple student groups, including campus-wide groups, department-wide groups, program-wide groups, special interest groups, course-wide groups, section-only groups, etc. Other groups include sponsored, ad hoc, invitational (e.g., class study groups that are sign up for), ad hoc invitational (e.g., student friends.), ad hoc, advertised (e.g., high school administrators). One embodiment of the present invention uses geolocation information to enable online activities to be viewed by those in groups.

The learning environments are defined by application software programs that present instructional material to students based on various user profiles, e.g., student or teacher profiles. Some user profiles include geo-location information associated with corresponding users. Such profiles are stored in databases accessible by various learning session application software running over a network of server computers. By running or executing the learning session application software over a wireless network various location specific workbooks are executed on at least some of the workstation devices used by students, teachers, classmates and others who are related to the student, such as parents, family and friends.

In one learning session, the workbooks could have gadget style and user-configurable layout. Under this type of learning session, the student workbooks are configurable and adaptable by the students to fit their needs. The learning session created under this arrangement could have a contemporary and leading edge look and feel tailored to include the goal-oriented needs of the students without the need to push content to them. Another type of learning session created under the present invention could have the format employed by immersive computer games using head's-up displays, transparent layers that are functional and intuitive. Still another type of learning session could be conservative and traditional. For example, when classes are selected, student can open their content with tabs. Geolocation information according to the present invention could be used to change student experiences by presenting different types of learning sessions based on position information of students.

Accordingly, the present invention executes location-specific student and teacher, workbook software at user devices that are capable of being located, either passively or actively, within a network over which instructional content could be transported. Such execution could take place at the user's workstation or at a network node that serves virtual user workbook applications over a network, including over virtual networks and cloud of networks.

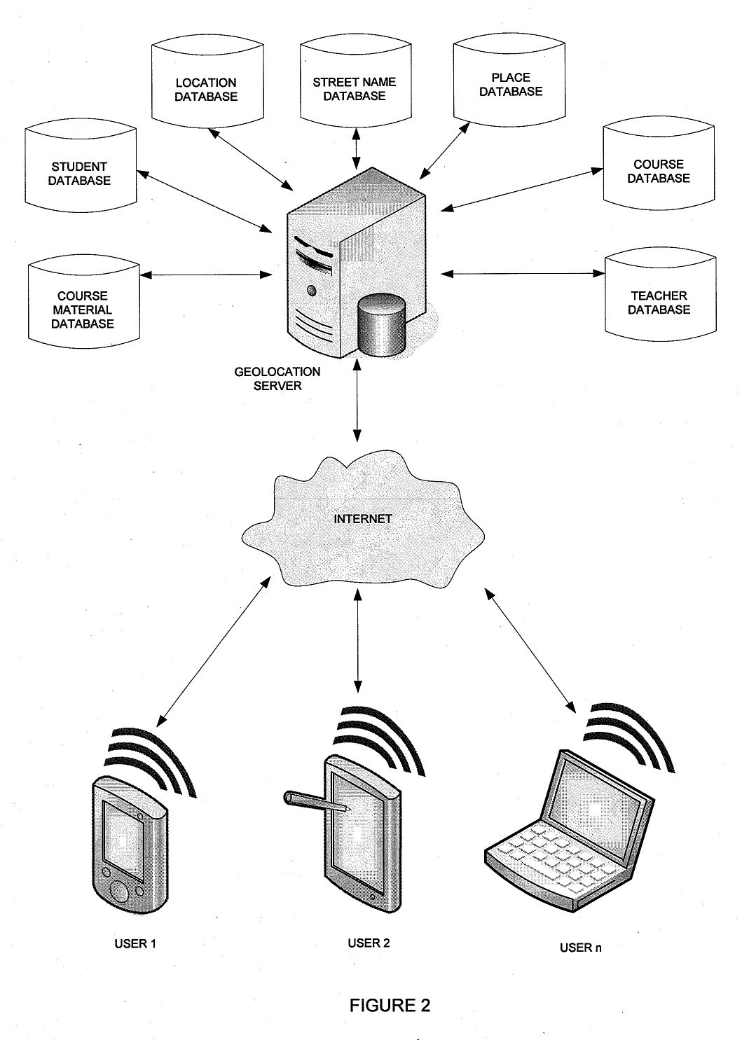

FIG. 2 is a block diagram of one embodiment of an educational system that uses geo-location information for educational courses. According to the present invention, the courses comprise learning units that are designed to create learning sessions based on geolocation information, where suitable course material are delivered to students, individually or in a group, based on geo-location information. In this embodiment, users 1-n are registered within a particular learning system or institution and may connect to a network (i.e. the Internet) through a mobile device, for example, a PDA, an iPad or a laptop computer. A geolocation server, maintained by the school/university or a third party vendor, may include an inventory of all users that are affiliated with the particular learning program or institution. In one embodiment, such users are associated with network address, e.g., IP addresses, that may be stored in a user's profile. When a user turns on his or her mobile device and accesses the Internet, the geolocation server executes geolocation processes to determine the user's geographical location, e.g., based on received GPS coordinates or IP address or any other suitable geolocation method. In one embodiment, the geolocation server may have access to one or more user location databases, with details of the user locations, including a street name database and/or a place database, as is well known in the art. Google Map technology could be used in conjunction with the present invention to enable serving geo-location information based on which location specific learning sessions are conducted for students or a class of students, individually or in groups. By accessing user profile data, the geolocation server may further determine a user type, for example, whether the user is a student, teacher, classmate, family, etc. The geolocation server may also identify which courses are associated with the user via a course database and what course materials are associated with the courses. In this way, the present invention tries to eliminate, as much as possible, unnecessary barriers between classrooms and between people, while providing a consistent, seamless, and enabling user interface across all applications that a student touches. In short, each individual institution is presented as part of a global network, and student as part of a global community.

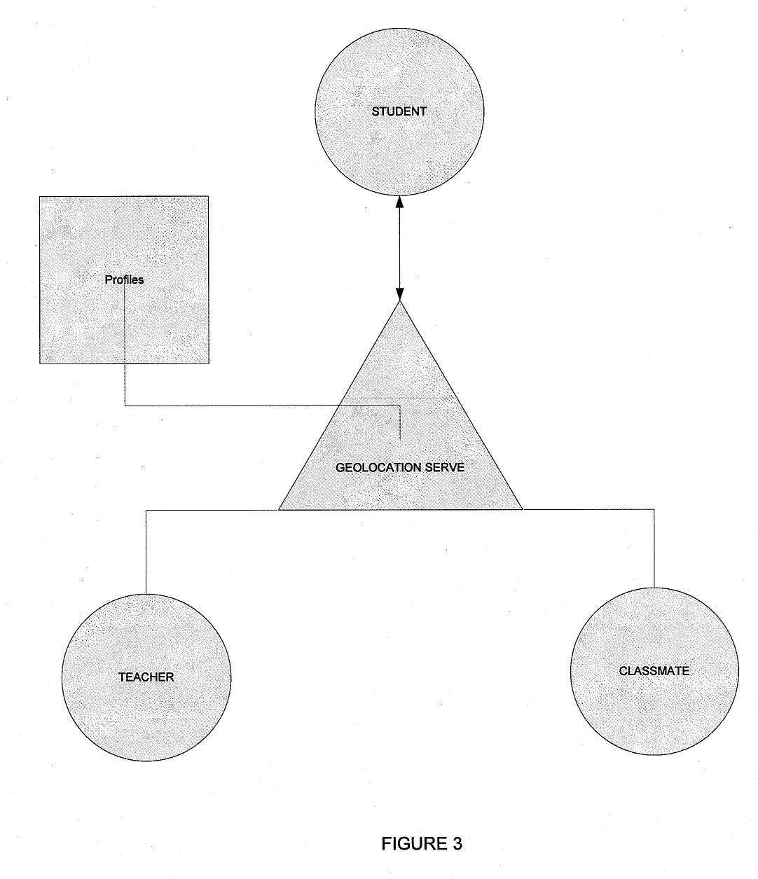

As shown in FIG. 3, the present invention associates geo-location information with profiles that comprise student information, course information, location information, learning unit information and instructional material information. For example, the geo-location information could be associated with a location that is associated with a course of study. Under this arrangement, the geo-location information could correspond to a city in a history course that involves the study of events at that city during a certain period. Depending on the course of study, the coordinates associates with geolocation information could be of any ascertainable shape, size or length in one, two or three dimensions. The geo-location information could specify a continent or a spot in a research laboratory or library among may other variations.

Course material contain instructional content, e.g., lectures, media content, tests, presentations, web addresses, study plans, etc. For example, geolocation information may be used in an online or mobile education system for the following purposes: 1) to dynamically create classes when at least one student and one teacher are within a defined proximity or zone, 2) to dynamically create classes when the number of classmates within a defined proximity or zone exceeds a predetermined number, 3) to engage a group of students assigned to a teacher in a learning session based on geographical location and/or proximity of the students to one another, 4) to create learning session for an individual student or a group of students enrolled in a course of study based on geographical location and/or proximity to a locations that is associated with the course of study, 5) to trigger the delivery of instructional material to students and/or teachers based on a geographical information, 6) to create learning sessions or trigger the delivery of instructional content based on events that are associated with a geographical location. An event for example may relate to crossing a delineated boundary or entry into a defined zone at a specified time. The occurrence of an event can be detected if a condition associated with a location is satisfied based on a predefined satisfaction criteria.

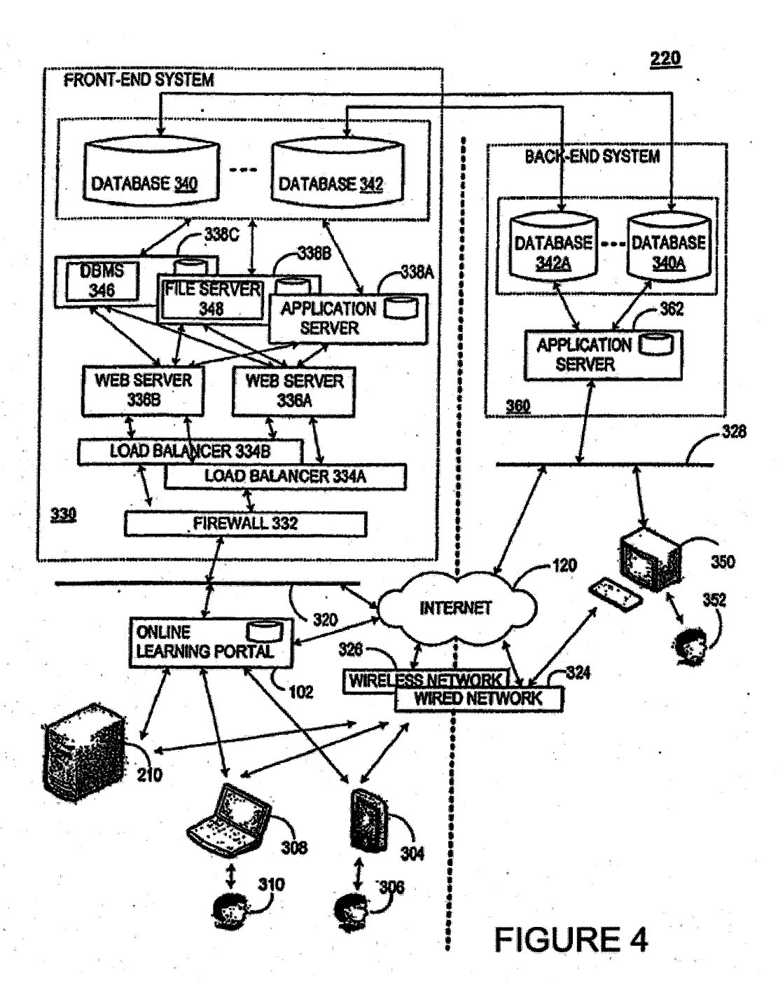

FIG. 4 shows the block diagram of a network having a front-end system and a back-end system. The front-end system 330 includes a firewall 332, which is coupled to one or more load balancers 334a, 334b. Load balancers 334a-b are in turn coupled to one or more web servers 336a-b. To provide online learning sessions, the web servers 336a-b are coupled to one or more application servers 338a-c, each of which includes and/or accesses one or more front-end databases 340, 342, which may be central or distributed databases. The application servers serve various modules used for interaction between the different users and the learning system, including instructional enrolment module, course registration module, learning session management module, content delivery module, geo-location module, proximity module and event module. The geolocation module allows a student and/or teacher to interact with instructional content based on geographic location. The proximity module allows a teacher and/or students to interact with one another based on geographic proximity. The event module allows a teacher and/or student to interact with instructional material based on a geographical event. These modules may be run independently of each other based on corresponding teacher, student, geolocation and event profiles, as further described below.

Web servers 336a-b provide various user portals, including student, teacher, geolocation and event portals. The servers 336a-b are coupled to load balancers 334a-b, which perform load balancing functions for providing optimum online session performance by transferring client user requests to one or more of the application servers 338a-c according to a series of semantics and/or rules. The application servers 338a-c may include a database management system (DBMS) 346 and/or a file server 348, which manage access to one or more databases 340, 342. In the exemplary embodiment depicted in FIG. 4, the application servers 338a and/or 338b provide instructional content to the users 306, 310 which include electronic interfaces, progress reports, student profiles, teacher profiles, geolocation profiles, event profiles, as well as instructional content correlated with a student, teacher, course, school, location or event as processed by the geolocation server. Some of the instructional content is generated via code stored either on the application servers 338a and/or 338b, while some other information and content, such as student profiles, instructional material, teacher schedule, or other information, which is presented dynamically to the user, is retrieved along with the necessary data from the databases 340, 342 via application server 338c. The application server 338b may also provide users 306, 306 access to executable files which can be downloaded and installed on user devices 304, 310 for creating an appropriate learning environments and sessions, with branding and or marketing features that are tailored for a particular application, client or customer.

The central or distributed database 340, 342, stores, among other things, the web content and instructional material deliverable to the students. The geolocation database 340, 342 also stores retrievable information relating to or associated with students, teachers, responsible authorities, parents, learning centers, profiles (student, facilitator, teacher, faculty, course developer, assessor, etc.), billing information, schedules, statistical data, attendance data, enrollment data, teacher attributes, student attributes, historical data, demographic data, compliance data, certification data, billing rules, third party contract rules, educational district requirements, etc. Any or all of the foregoing data can be processed and associated as necessary for achieving a desired learning objective or a business objective associated with operating the system of the present invention.

Updated program code and data are transferred from the back-end system 360 to the front-end system 330 to synchronize data between databases 340, 342 of the front-end system and databases 340a, 342a of the back-end system. Further, web servers 336a, 336b, which may be coupled to application servers 338a-c, may also be updated periodically via the same process. The back-end system 360 interfaces with a user device 350 such as a workstation, enabling interactive access for a system user 352, who may be, for example, a developer or a system administrator. The workstation 350 may be coupled to the back-end system 360 via a local network 328. Alternatively, the workstation 350 may be coupled to the back-end system 360 via the Internet 120 through the wired network 324 and/or the wireless network 326.

The back-end system 360 includes an application server 362, which may also include a file server or a database management system (DBMS). The application server 362 allows a user 352 to develop or modify application code or update other data, e.g., electronic content and electronic instructional material, in databases 340a, 342a. According to one embodiment, interactive client-side applications on the internet execute on a variety of internet delivery devices such as a web-browser, smart phones, and tablet devices such as the iPad, to provide an improved core student experience.

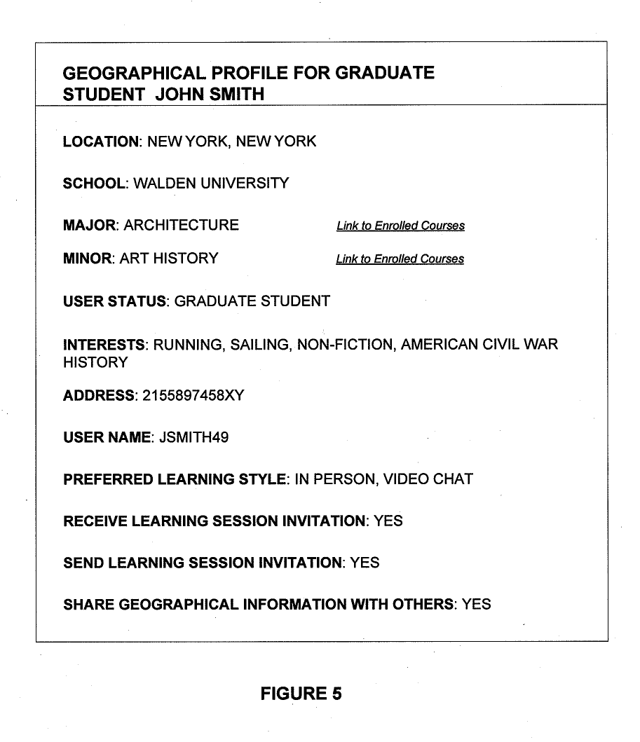

FIG. 5 depicts a student profile example stored and accessed by the geolocation server, according to one embodiment of the present invention. The student profile may include the student name, school, location, major/minor, user status and/or interests of the enrolled student. Here, John Smith is a graduate architecture major, with a minor in art history, who likes to run, sail, read non-fiction and is interested in American Civil War history. Links to John's courses in both his major and minor are available. The student profile further includes an IP Address of John's mobile device which will allow the geolocation server to identify John and track his geographical location during use. The student profile may specify an online user name used for instant messaging, video chat, blogging and/or emailing. Additionally, privacy settings may be tailored within the student profile to enable or disable the student's ability to receive a learning session invitation, initiate a learning session invitation and/or share geographical information with others. The student may also set his/her preferred learning style. This information will be considered by the geolocation server while tracking and communicating with the specified student.

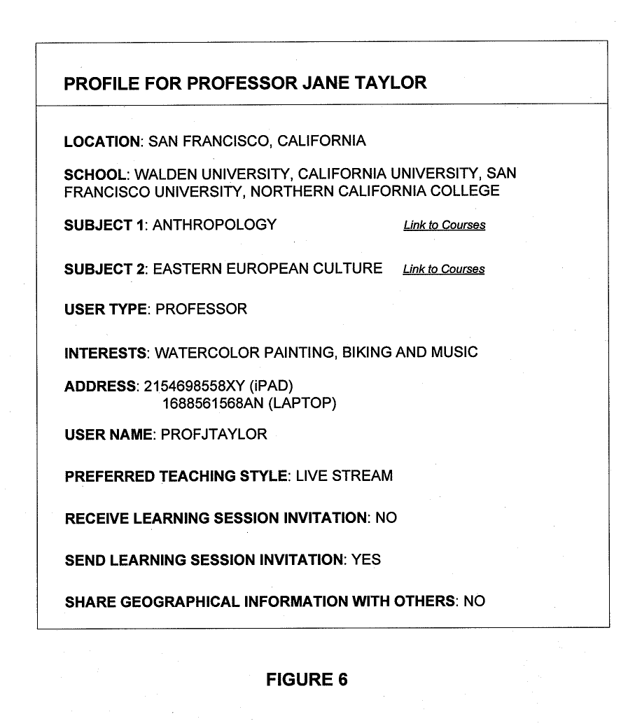

FIG. 6 depicts a teacher profile stored and accessed by the geolocation server, according to one embodiment of the present invention. The teacher profile includes the name of the teacher, his/her primary location and his/her user status, as well as the various school affiliations of the teacher. Here, Professor Jane Taylor teaches at four different colleges and universities in California. Professor Taylor teaches two subjects: anthropology and Eastern European culture. Additional teaching subjects may be added depending on the teacher's course load. The teacher may also include her outside interests, here watercolor painting, biking and music.

The teacher profile may include information about the teacher's mobile device(s), e.g., the IP Address(es), so that the geolocation server may recognize the teacher and track his/her location using a suitable geo-location process. The teacher profile may also include the teacher's online user name and the teacher's preferred method of teaching. In this embodiment, Professor Taylor prefers live stream video rather than in-person interaction with students. Like the student, a teacher may chose his or her own privacy settings. Here, Professor Taylor has limited her privacy settings to sending learning session invitations to others. For personal or professional reasons, Professor Taylor has decided not to receive learning session invitations from other teachers and/or students and not to share geographical information with others. Such privacy decisions remain with the user, not with the system.

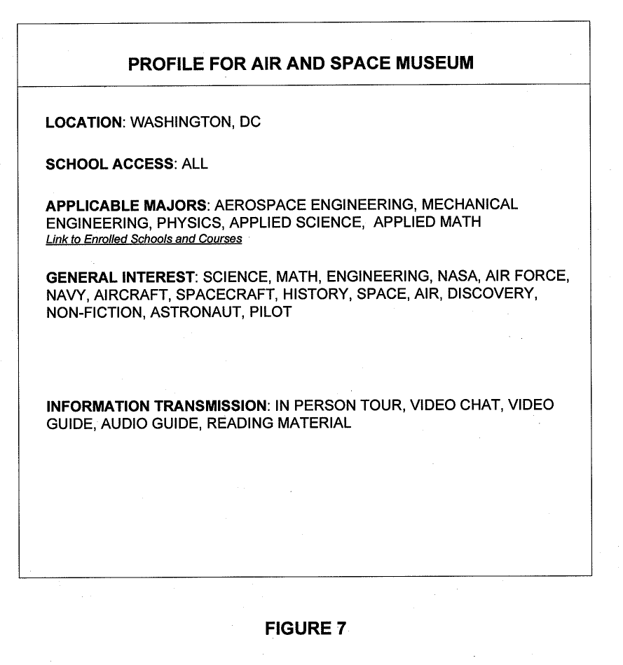

FIG. 7 depicts a place of interest profile stored and accessed by the geolocation server, according to one embodiment of the present invention. The place of interest profile may include the name and location of the landmark or place of interest. Here, a geolocation profile has been created for the Air and Space Museum in Washington, D.C. The geolocation profile has been created for access by students and teachers in all online system schools. The geolocation profile includes a list of applicable majors to the general learning content of the museum. Such majors include aerospace engineering, mechanical engineering, applied science, physics and applied math. A link to the schools and applicable courses for such majors may be included.

Furthermore, the geolocation profile may include a list of general interest categories. The list in the present embodiment includes science, math, engineering, NASA, Air Force, Navy, aircraft, space craft, history, space, air, discovery, non-fiction, astronaut and pilot categories. These general interest items and applicable majors may be compared to those entries in a teacher and/or student profile. For example, if a student enrolled in an aeronautics course with a spacecraft-related learning unit comes within the vicinity of the Air and Space Museum, the geolocation server may correlate the common interest and send a learning session prompt to the student.

The geolocation profile may further specify how instructional content may be transmitted. Here, the Air and Space Museum offers in-person tours, live video chat with a museum curator, an audio guide and instructional reading material. A system installed by the place of interest or landmark may further elect to receive learning session invitations, send learning session invitations and share geographical information with others. For example, the Air and Space Museum may advertise a special exhibit on “Terrestrial Geology and Geophysics” to students enrolled at a particular institution within a quarter mile of the Museum. Likewise, a student planning to visit the Air and Space Museum on a particular day may send a request to the Museum for a learning session on a particular topic prior to arriving.

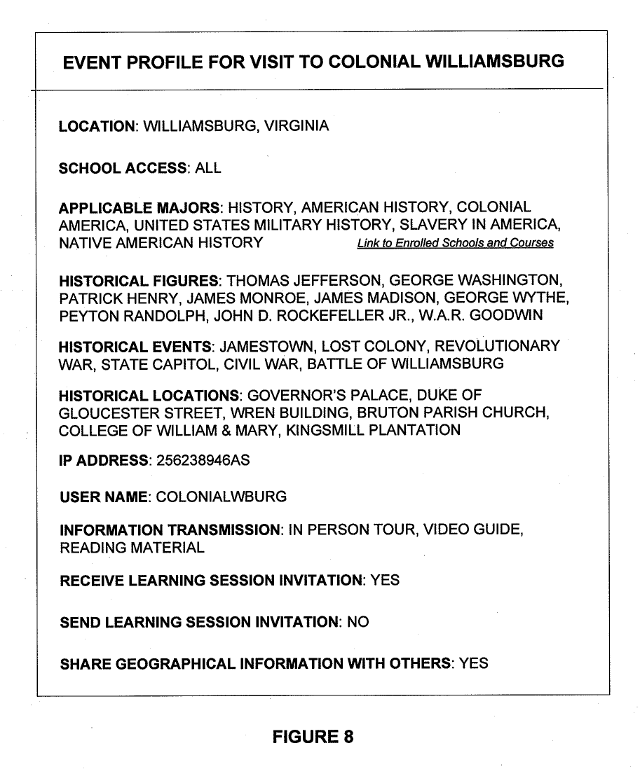

FIG. 8 depicts an activity profile stored and accessed by the geolocation server, according to one embodiment of the present invention. Here, the activity profile is for a visit to Colonial Williamsburg. The activity profile includes the location of the activity, as well as the access settings for schools listed within the system. Here, the activity will take place in Williamsburg, Va. and it is accessible to all schools within the system. Similar to above, a list of applicable majors to the event are listed, including history, American history, etc. The event profile further includes three special categories, including historical figures, historical events and historical locations. Again, the information in each of these categories may be matched to the profile of a teacher and/or student. For example, a student with an interest in the Civil War may be directed by the geolocation server to a reenactment of the Battle of Williamsburg, as described in the event profile.

Learning Session Triggered by Student Location.

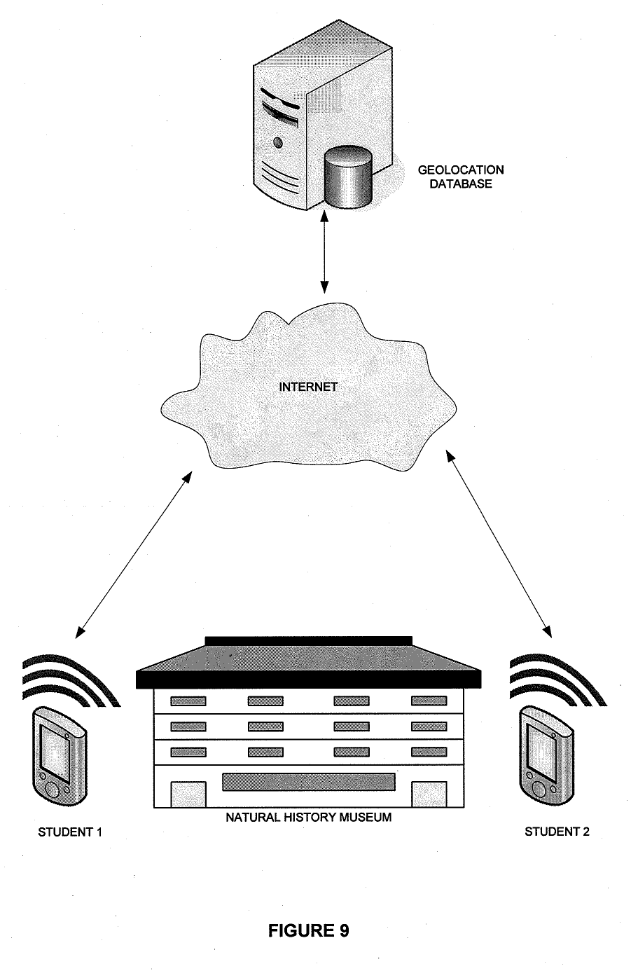

FIG. 9 shows an exemplary schematic diagram of instructional content delivery triggered by a student's geographical location. In this embodiment, students 1 and 2 are located in the vicinity of a Natural History Museum. Each student is using a mobile device, for example a smart phone and/or a PDA, which may broadcast its IP address over a network. As described above, the IP address may be received by a geolocation server over the network. The geolocation server may identify each student's geographical location, using, for example, the student's IP address and a coordinate system. A place database may further correlate the student's coordinates with those of the nearby Natural History Museum This correlation may prompt the database to deliver instructional material, relating to the Natural History Museum or the subject of natural history, to the students. Thus, the students may read educational information during an actual visit to the Museum. Further, if the student was unaware of his/her proximity to the Museum, it may prompt him or her to go take a visit. Thus, the geolocation software promotes “on the go” educational experiences for students both outside of the classroom and outside of regular school hours.

Learning Session Triggered by Student Geographical Proximity to Teacher.

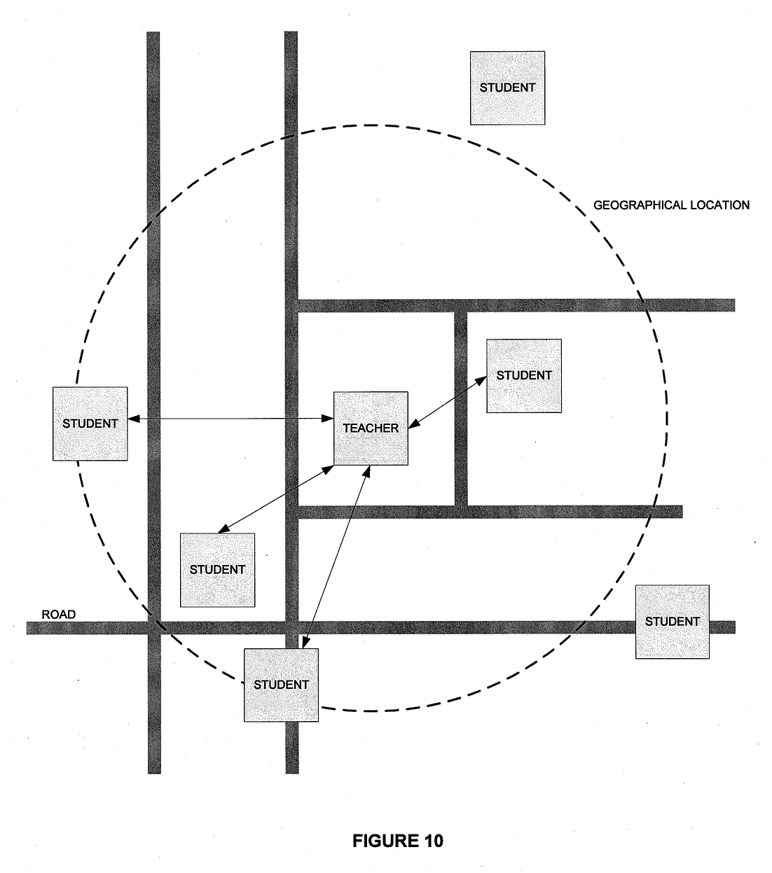

FIG. 10 shows a schematic diagram of engagement of at least one student and a teacher in a learning session based on geographical location and/or proximity of the student and the teacher to one another. In this embodiment, four students are identified by the geolocation server based on geographic proximity to a teacher. The geolocation server may send each student a prompt to enter into a learning session with the teacher. The prompt may be an instant message from the server stating “Professor Jones is near your current location. Are you interested in some additional math tutoring?” Positive student responses may be forwarded to the teacher, who may then send out a message with a meeting time and place. The learning session, for example, may be conducted online, by video, by conference call or in person.

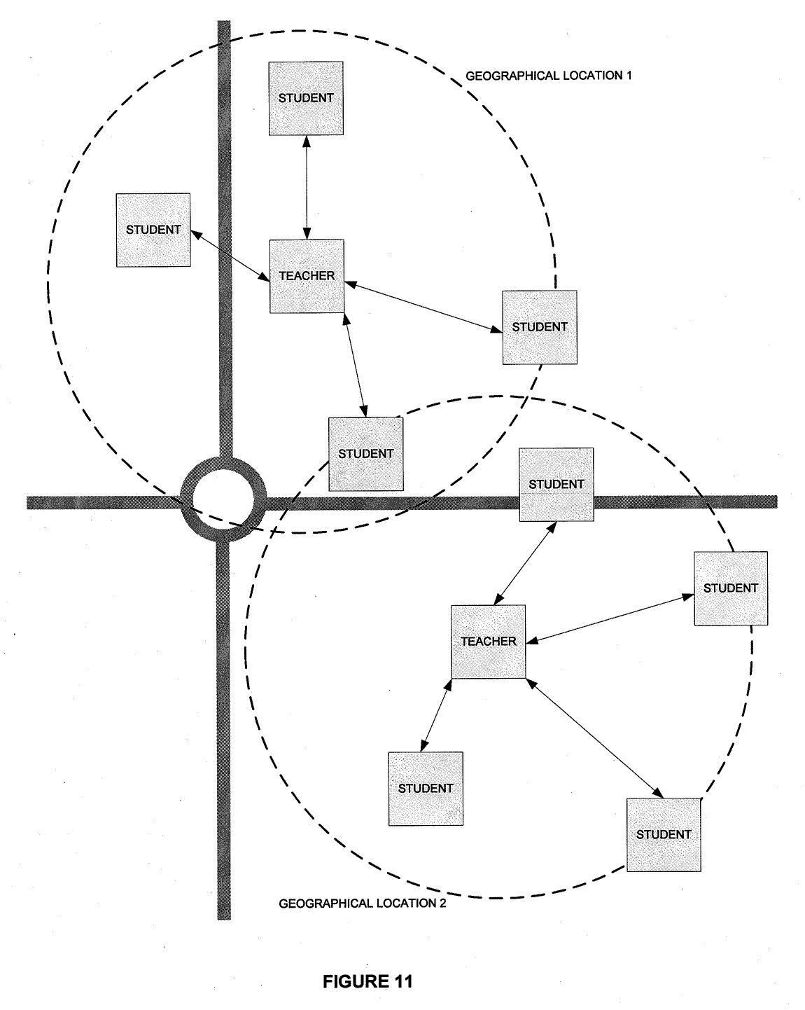

FIG. 11 shows another embodiment of FIG. 10, whereby the geolocation educational system may engage two sets of students and teachers based on geographical location and/or proximity of the students and teachers to one another. Here, eight students are divided up between two teachers for instruction based on their proximity to each teacher. The system may specify limits on the number of students a teacher may engage in a learning session or the distance from which a teacher may engage a student in a learning session.

Learning Session Triggered by Student Geographical Proximity to Another Student.

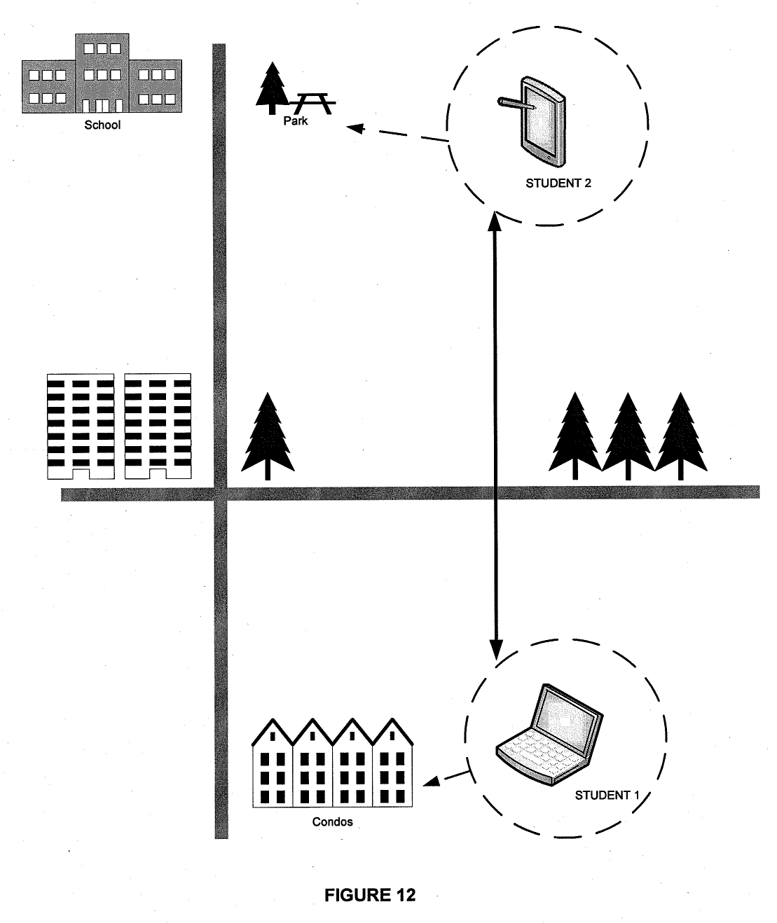

FIG. 12 shows a schematic diagram of student collaboration and communication based on geographical location and/or proximity of two or more students. Here, for example, student 1 may be working on her laptop from her condo building and student 2 may be working on his iPad in the park across from the school. The geolocation server may pick up each student's IP address, track their respective geographic locations and send out an alert to one or both students that they are within the same geographical area. Furthermore, the geolocation server may identify a common course or a common activity each student is engaged with. For example, a message on Student 1's laptop might read “Student 2 is studying statistics at the park” or Student 2's iPad might read “Student 1 is reading Chapter 2 of ‘Statistics for Engineers’ one mile from your current location.” A message prompt might read “would you like to send the student an invitation to study?” or “would you like to send a message?” Thus, the system encourages student 1 and student 2 to communicate either by studying statistics together or by sending statistics questions back and forth between them. It is further comforting for student 1 and 2 to know that someone nearby is laboring through the same statistics problems as they are. This, in essence, integrates each student into each other's learning environments. Each student is no longer isolated within their individual online world.

Teacher Collaboration Triggered by Geographic Proximity of Teachers in Similar Field of Education.

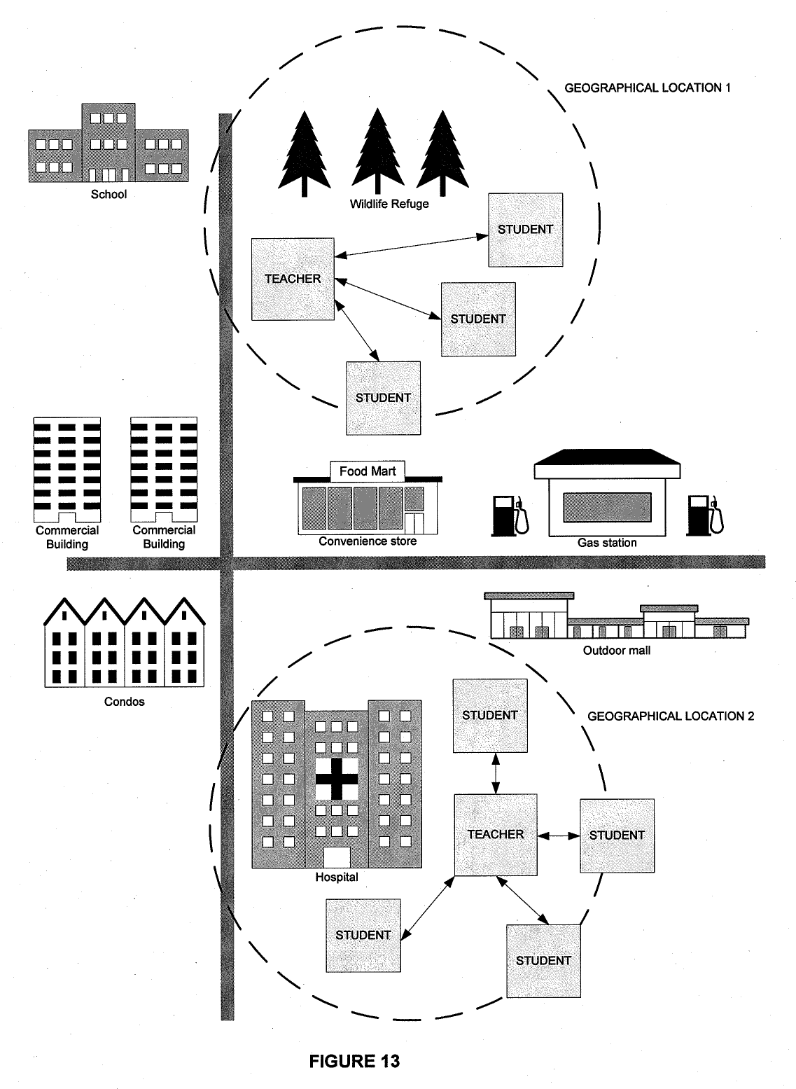

FIG. 13 depicts a schematic diagram of collaboration between teachers based on geographic proximity and similar field of education, according to one embodiment of the present invention. In this embodiment, several teachers are gathered in a faculty lounge at a university. Given the large faculty of many learning institutions and the use of adjunct faculty, it is possible that the teachers may not know one another. In this case, the IP addresses of two biology teachers in the group are picked up by the geolocation server and are correlated to one another based on location and the common field of teaching. A message prompt may be sent to one or both teachers. Based on this message prompt, the two biology teachers are introduced to one another and may then make time to discuss teaching strategy and/or to discuss a developing trend in the field of biology. This geo-aware feature encourages faculty to collaborate and share information with one another. This collaboration is to the benefit of the students.

Learning Session Triggered by Geographic Location and Student Geographical Proximity to Teacher.

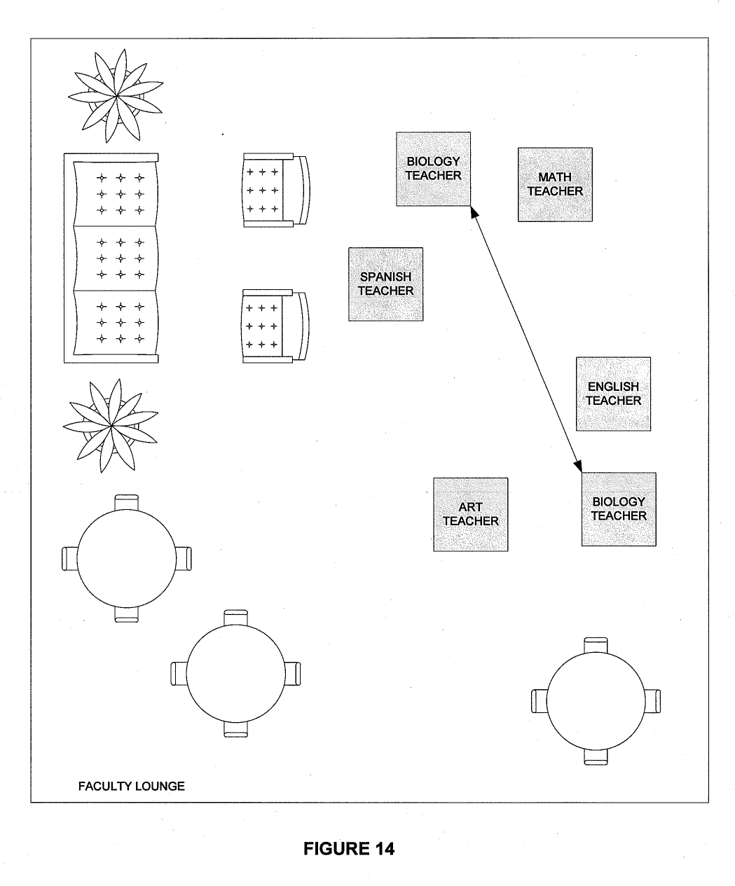

FIG. 14 shows a schematic diagram wherein at least one student and teacher are engaged in a learning session based on geographical location and/or proximity of the student and teacher to one another, as well as the delivery of instructional content based on a group's proximity to a landmark. Here, for example, the geolocation database may identify that a biology teacher and three biology students are all within close proximity to each other. The system may send the three students and teacher an invitation to engage in a learning session. At the same time, the geolocation server may also recognize the teacher and students' close proximity to a National Wildlife Refuge and may prompt the instructional content database to forward an article about local bird species to each of the students.

In a second embodiment depicted in FIG. 14, a hospital may employ a number of volunteer nursing students during the semester. A senior nurse, also a professor of nursing, may wish to offer some practical training to the volunteer nursing students once or twice a week, depending on her schedule. The senior nurse may send an impromptu learning session inquiry through the geolocation server to see whether any of the on-site nursing students are currently interested in additional training. The geolocation server may then identify which nursing students are present at the hospital and may send each student a learning session request from the senior nurse. Nursing students who are present and available may confirm their interest by responding on their PDA and may meet up with the senior nurse for a training session at the specified time. This enables spur of the moment training and learning sessions based on location.

Similarly, in this embodiment, the geolocation database, recognizing that a nursing student is at the hospital, may send a prompt for the delivery of instructional content. The prompt may read “It appears that you are currently at General Hospital, would you like a map of the hospital, a listing of the doctors and practice areas, or any reference materials to assist you today?” This enables' nursing students to quickly access information and reference materials during their training and hands-on experience. This is clearly much more efficient than each nursing student bringing his or her textbooks with him or her during each volunteer session.

Learning Session Triggered by Geographical Event.

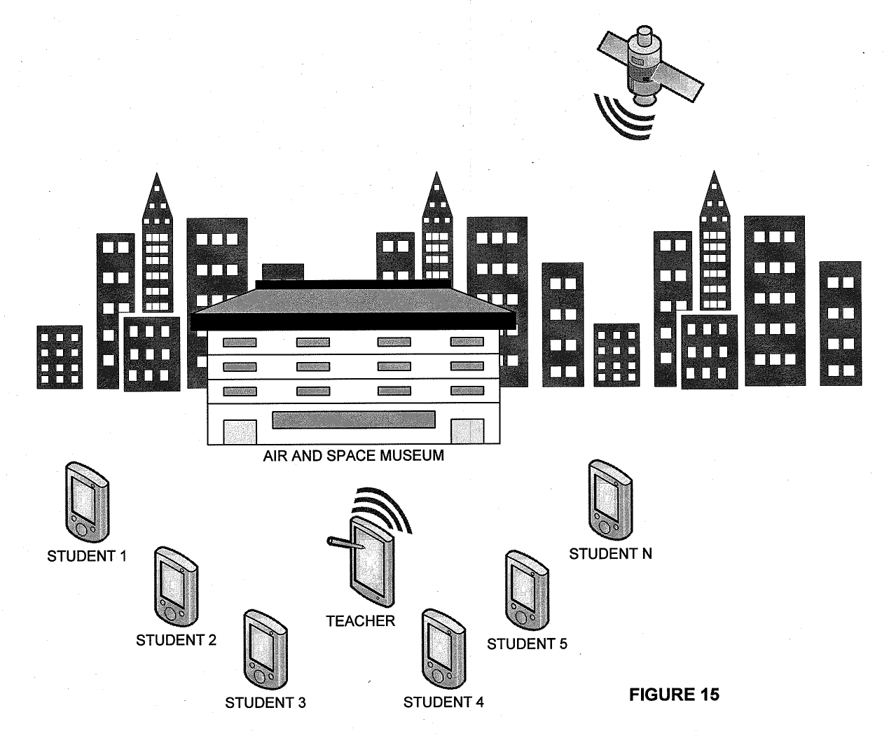

FIG. 15 shows a schematic diagram of a scenario wherein a teacher engages at least one student in a learning session based on an event, according to one embodiment of the present invention. Here, the teacher, a professor of art history, is teaching a course at a local university on “The Works of Claude Monet.” The course has students 1-n, who may be either art history majors or minors, or may be students who are simply interested in the subject matter of Monet. In this embodiment, the teacher has met students 1-n at the Art Museum. The Art Museum may, for example, have a special exhibit on Claude Monet's “Boat Studio” series. The teacher may send a request to the geolocation server to have pre-selected instructional material in the database delivered to the mobile devices of each student. The teacher may request additional teaching material for him/herself. The teacher may opt to directly lecture to the group during the visit, or may send the students off individually to view the paintings and interact with the instructional media sent to their mobile devices at their own pace.

Following the lecture, one or more students may elect to remain at the Art Museum to view additional exhibits. Each student may contact the geolocation server to request additional instructional material from the database. For, example, while one student may be interested in viewing the sculpture gallery another student may be interested in seeing the modern art wing. These students may request information from the geolocation database based on art type, location within the museum, artist, art medium, time period, etc. Additionally, individual art pieces of the Art Museum may include IP transmitters which may alert the geolocation server when a particular student has reached that particular art exhibit. A prompt may appear on the student's mobile device suggesting instructional material based on that art piece.

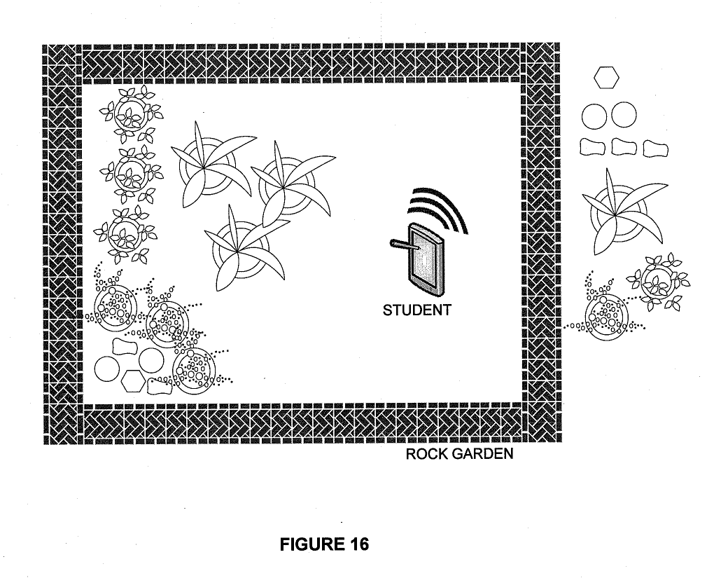

FIG. 16 shows a schematic diagram of a scenario wherein a student engages him- or herself in a learning session based on an event, according to one embodiment of the present invention. Here, the student, a landscape architecture major, is designing and building a rock garden for a local community park based on a school project. During the project, the student may use his/her mobile device to contact the geolocation server to request instructional information. For example, the geolocation server may recognize the location of the student in the community park and may send information to the student relating to the history, the soil type and local geology, the plant and wildlife, the environmental considerations, and/or the local use of the park. This may enable the student to design the rock garden in view of existing social, ecological, and geological conditions and processes in the landscape, and the design of interventions that will produce the desired outcome. The school and/or teacher may further provide a list of instructional materials for the project, which the student may access while working on the rock garden. This real-life project, in combination with full access to course materials, will help reinforce the student's traditional learning in the classroom. This further combines a student's traditional education with a better understanding of his/her local environment.

Exemplary Web Portals.

In order to facilitate the use of geolocation or geo-aware technology, web portals particular to the mobile device of the user should be employed. Depending on the technology skill level of the student, web portal design may be divided into three general categories: 1) conservative/traditional web portals, 2) aggressive/progressive web portals and 3) outrageous/outlandish web portals. The web portals will differ depending on whether they are presented on a laptop, a smart phone, an iPad or a Netbook.

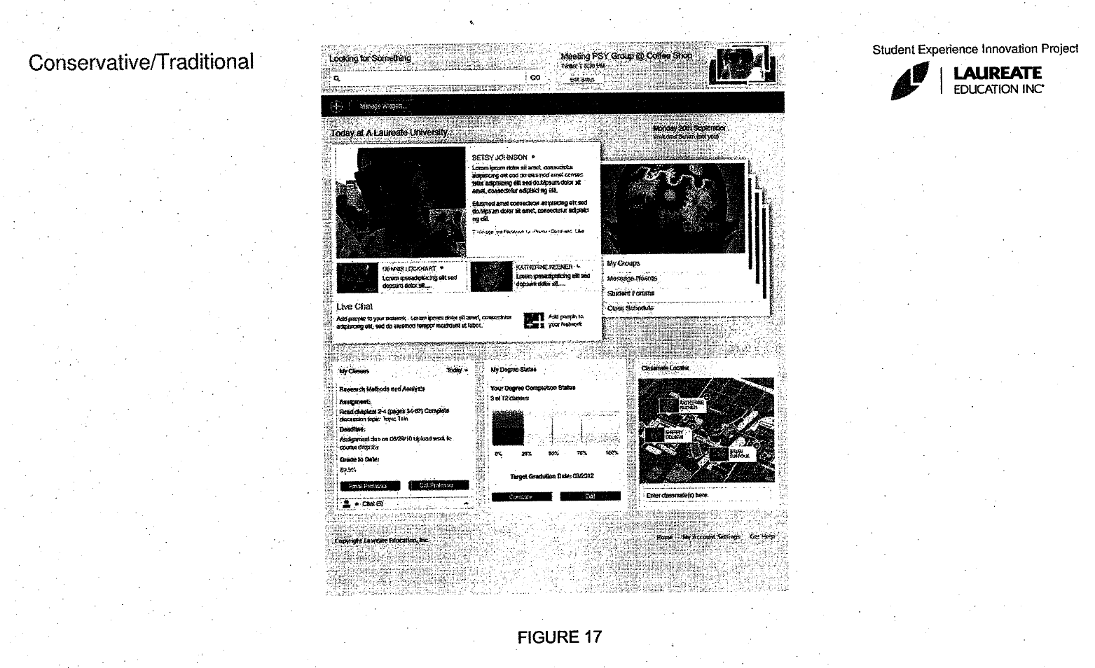

FIG. 17 depicts a web portal displaying geolocation information to a user, according to an embodiment of the invention. A “classmate locator” shows the user, here a student, where three of her classmates are currently located on campus. This allows the student to coordinate with one or more of these classmates to study together or to meet for coffee or lunch. A student may arrange the classmate locator on any portion of his/her screen and in any size. The student may type in the name of a particular classmate to see whether they are currently online in a nearby location. If the classmate is unavailable, the geolocation server may send the student a notification when the classmate enters the student's geographical location.

Further, a “my degree status” window may show the user his/her degree completion status. According to one embodiment, the geolocation server may provide information to the student regarding the progress status or activity status of those classmates within close geographical proximity to him/her. For example, a status message might indicate that “Katherine has completed more than 50% of her degree requirements,” or “Katherine is on page 4 of her anthropology paper.” This allows the student to compare his/her progress to those of his/her classmates. For example, the geolocation server may provide a student with information on the completed courses of a classmate at a nearby location. The student, who may be currently taking one of those completed courses, may then instant message the classmate for homework help or tutoring.

It will be understood that the above description of the present invention is susceptible to various modifications, changes and adaptations, and that the same are intended to be comprehended within the meaning and range of equivalents of the appended claims.

1. An location based system for conducting learning sessions comprising:
a geolocation server configured to access a location information for at least one of a plurality of students or a location information for at least one of a plurality of teachers;
an enrollment module configured to enroll the at least one of the plurality of students in at least one of a plurality of courses taught by the at least one of the plurality of teachers;
a learning session management module configured to manage a learning session associated with the at least one of the plurality of courses based on at least one of the location information for the at least one of the plurality of students or the location information for the at least one of the plurality of teachers.

2. The system of claim 1, wherein managing the leaning session comprises matching one of the plurality of students enrolled in a course with a teacher that teaches the course based on a relative proximity of the one of the plurality of students and the teacher.

3. The system of claim 1, wherein managing the learning session comprises creating the learning session associated with a course when a number of students that are within a relative proximity exceeds a predefined number.

4. The system of claim 3, wherein creating the learning session requires sending a session invitation to a student.

5. The system of claim 1, wherein managing a leaning sessions comprises matching at least one student enrolled in a course with at least one other student enrolled in the course based on a relative proximity of the one and the other students.

6. The system of claim 5, wherein creating the learning session requires sending a session invitation to one of the students.

7. The system of claim 1, wherein said geolocation information is associated with a place of interest related to a course, wherein managing a leaning sessions comprises matching at least one student enrolled in the course based on a relative proximity of the student and the place of interest.

8. The system of claim 1, wherein managing a learning session comprises delivering instructional material associated with a course to a student enrolled in the course based on the location of the student.

9. The system of claim 1, wherein managing a learning session comprises delivering instructional material associated with a course to a teacher that teaches the course based on the location of the teacher.
